(19) United States
(12) Patent Application Publication
(10) Pub. No.: US 2026/0142516 A1
(43) Pub. Date: May 21, 2026

(54) E-MOTOR BUSBAR SPRAY OUTLET

(71) Applicant: Schaeffler Technologies AG & Co. KG, Herzogenaurach (DE)

(72) Inventors: Christopher Chapanar, Massillon, OH (US); Kyle Nelson, Delaware, OH (US); Adit Ajikumar, Wadsworth, OH (US); Daniel de Ceballos, Atlixco (MX)

(73) Assignee: Schaeffler Technologies AG & Co. KG, Herzogenaurach (DE)

(21) Appl. No.: 19/258,928

(22) Filed: Jul. 3, 2025

Related U.S. Application Data
(60) Provisional application No. 63/721,113, filed on Nov. 15, 2024.

(51) Int. Cl. H02K 3/24; H02K 5/20; H02K 5/22

(52) U.S. Cl. CPC H02K 3/24; H02K 5/20; H02K 5/225

(57) ABSTRACT

An electric motor cooling system includes wire coils, a housing, a busbar, and a phase bar secured to the busbar. The housing encloses at least a portion of the wire coils. The busbar is connected to the wire coils and extends through an opening in the housing. The cooling system is arranged to direct a cooling fluid through the plurality of wire coils and a gap between the opening and the busbar to spray the phase bar.

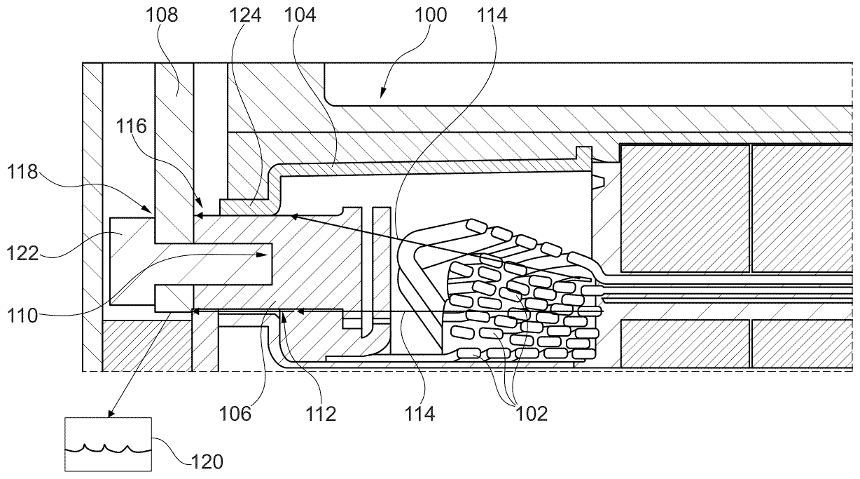

### CROSS-REFERENCE TO RELATED APPLICATIONS

This application claims the benefit of U.S. Provisional Patent Application No. 63/721,113, filed Nov. 15, 2024, the disclosure of which is incorporated in its entirety by reference herein.

### TECHNICAL FIELD

The present disclosure relates generally to an e-motor, and more specifically to an e-motor phase bar spray outlet.

### BACKGROUND

E-motor stator cooling is known. One method is shown and described in commonly-assigned United States Patent Application Publication No. 2024/0258870 titled WINDING HEAD COOLING to Gramann et al., hereby incorporated by reference as if set forth fully herein.

### SUMMARY

Example aspects broadly comprise an electric motor cooling system including wire coils, a housing, a busbar, and a phase bar secured to the busbar. The housing encloses at least a portion of the wire coils. The busbar is connected to the wire coils and extends through an opening in the housing. The cooling system is arranged to direct a cooling fluid through the plurality of wire coils and a gap between the opening and the busbar to spray the phase bar.

### BRIEF DESCRIPTION OF THE DRAWINGS

The single FIGURE illustrates a cross-sectional view of a portion of a stator assembly for an electric motor.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the FIGURES can be combined with features illustrated in one or more other FIGURES to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The following description is made with reference to the single FIGURE. The single FIGURE illustrates a cross-sectional view of a portion of a stator assembly for an electric motor. Electric motor cooling system 100 includes wire coils 102, housing 104, busbar 106 and phase bar 108 secured to the busbar. The housing encloses at least a portion of the wire coils. Busbar 106 is connected to the wire coils and extends through opening 110 in the housing. Cooling system 100 is arranged to direct a cooling fluid through the plurality of wire coils and gap 112 between the opening and the busbar to spray the phase bar, as indicated by arrows 114, for example.

As shown in the FIGURE, phase bar 108 is secured to busbar 106 at connection point 116. Cooling fluid (indicated by arrows 114) sprays the connection point. That is, cooling fluid outlet 118 of the busbars is arranged at a location where the phases leave the enclosure and is aimed at connection point 116 to a power source (not shown) to directly cool a critical thermal connection. By moving the outlet to a point where the busbars leave the housing, a pass-through between the busbars and the housing need not be sealed in a conventional manner. After cooling the connection point, the cooling system is arranged such that the fluid flows to sump 120 to lubricate nearby components (not shown) and return to a cooling loop.

Connection point 116 is secured by bolt 122. Housing 104 includes necked portion 124 extending towards the phase bar and the busbar extends through the necked portion. Gap 112 is arranged between the necked portion and the busbar. Wire coils 102 are part of an electric motor stator.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

REFERENCE NUMERALS

| | |
|---|---|
| 100 | Electric motor cooling system |
| 102 | Wire coils |
| 104 | Housing |
| 106 | Busbar |
| 108 | Phase bar |
| 110 | Opening (housing) |
| 112 | Gap (opening and busbar) |
| 114 | Arrows (cooling fluid) |
| 116 | Connection point |
| 118 | Cooling fluid outlet |
| 120 | Sump |
| 122 | Bolt (connection point) |
| 124 | Necked portion (housing) |

What is claimed is:

1. An electric motor cooling system, comprising:
a plurality of wire coils;
a housing enclosing at least a portion of the wire coils;
a busbar connected to the wire coils and extending through an opening in the housing; and
a phase bar secured to the busbar, wherein the cooling system is arranged to direct a cooling fluid through the plurality of wire coils and a gap between the opening and the busbar to spray the phase bar.

2. The electric motor cooling system of claim 1, wherein:
the phase bar is secured to the busbar at a connection point; and
the cooling fluid sprays the connection point.

3. The electric motor cooling system of claim 2, wherein the connection point is secured by a bolt.

4. The electric motor cooling system of claim 1, wherein:
the housing comprises a necked portion extending towards the phase bar; and
the busbar extends through the necked portion.

5. The electric motor cooling system of claim 4, wherein the gap is arranged between the necked portion and the busbar.

6. The electric motor cooling system of claim 1, wherein the wire coils are part of an electric motor stator.
